(19) United States
(12) Patent Application Publication
(10) Pub. No.: US 2010/0015367 A1
(43) Pub. Date: Jan. 21, 2010

(54) Novelty Sports Accessory Apparatus with Coupling Adaptor

(76) Inventor: James David Mitchell, Powder Springs, GA (US)

Correspondence Address: PHILIP H. BURRUS, IV, 460 Grant Street, Atlanta, GA, 30312, US

(21) Appl. No.: 12/173,168

(22) Filed: Jul. 15, 2008

(51) Int. Cl. B60R 13/00

(52) U.S. Cl. 428/31; 40/591

(57) ABSTRACT

A novelty sporting accessory (100) includes a placard (101) having text (103) disposed thereon. A coupling device (104) is coupled to the placard (101). The coupling device (104) can be configured to couple to trailer hitch assemblies, windows, rear-view mirrors, antennas, trailer hitch balls, walls, and other devices. A first thin length (111) and second thin length (112) of flexible material are coupled to either the placard (101) or the coupling device (104). A sporting appurtenance (113,114) is coupled—distally from the placard (101)—to the lengths of flexible material so as to dangle when the placard (101) when the placard (101) is arranged in a vertical orientation.

### BACKGROUND

1. Technical Field

This invention relates generally to a novelty accessory, and more particularly to a novelty accessory for displaying enthusiasm or interest in sports.

2. Background Art

People have long used novelty items for entertainment and amusement purposes. Novelty items can be used to express humor or a particular interest. Novelty items can also be given as gifts. Novelty items take many forms, shapes, and sizes. People often value novelty items because they are clever, simple, and often invoke a smile.

Additionally, people often adorn their automobiles and homes with personalized stylizations. For example, people often adorn their vehicles with decals. Examples include campaign stickers, decals of favorite musical groups, decals of favorite quotations, and so forth. Similarly, people may hang posters on the wall in their home.

As both flat, sticker-type decals or flat, two-dimensional posters are so common, one can often look like another. As such, messages on decals can be overlooked, thereby marginalizing their novelty appeal. There is thus a need for a simple novelty item that is less likely to be overlooked by a viewer.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a front, elevation view of one sports novelty accessory in accordance with embodiments of the invention.

FIG. 2 illustrates a side, elevation view of one sports novelty accessory in accordance with embodiments of the invention.

FIG. 3 illustrates a perspective view of one sports novelty accessory in accordance with embodiments of the invention coupled to a trailer hitch assembly.

FIG. 4 illustrates a side, elevation view of one sports novelty accessory in accordance with embodiments of the invention coupled to a trailer hitch ball.

FIG. 5 illustrates a front, elevation view of one sports novelty accessory in accordance with embodiments of the invention.

FIG. 6 illustrates a side, elevation view of one sports novelty accessory in accordance with embodiments of the invention.

FIG. 7 illustrates a top, plan view of one sports novelty accessory in accordance with embodiments of the invention.

FIG. 8 illustrates a front, elevation view of one sports novelty accessory in accordance with embodiments of the invention.

FIG. 9 illustrates a side, elevation view of one sports novelty accessory in accordance with embodiments of the invention.

FIG. 10 illustrates a side, elevation view of one sports novelty accessory in accordance with embodiments of the invention.

FIG. 11 illustrates a front, elevation view of one sports novelty accessory in accordance with embodiments of the invention.

FIG. 12 illustrates a side, elevation view of one sports novelty accessory in accordance with embodiments of the invention.

FIGS. 13-40 illustrate a variety of sporting appurtenances suitable for use with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide a novelty sporting accessory with which one's enthusiasm for a particular sport or pastime can be cleverly displayed in a three-dimensional manner. Some embodiments of the invention are suitable for vehicular display. Others are suitable for use as keychain devices. Others are suitable for wall display in a home.

In one embodiment, the novelty sporting accessory includes a placard that may be oval or rectangular in shape. Disposed on the placard is text or other graphical indicia. In one embodiment, the text includes a first word representative of a sport—such as “soccer” or “golf”—and a second word “nuts.” Beneath the placard dangle sporting appurtenances, such as sporting balls, replica sporting balls, replica helmets, or other replica devices. In one embodiment, the sporting appurtenances are replica sporting balls dangling so as to suggest male testicular appendages. Thus, one embodiment may include the words “Golf Nuts” on the placard and a pair of golf balls dangling beneath the placard so as to suggest golf ball testicular appendages.

In one embodiment, the novelty sporting accessory includes a coupling device for coupling to a trailer hitch ball or trailer hitch receiver. In such a configuration, the novelty sporting accessory may be displayed at the rear of a vehicle. Such an embodiment may connote the image of a steer or stallion from behind. In another embodiment, the novelty sporting accessory may be coupled to a vehicular window, vehicular antenna, or vehicular rear-view mirror. In another embodiment, the novelty sporting accessory can be configured as a keychain. In yet another embodiment, the novelty sporting accessory can be configured to be mounted on a wall, such as within one's home. The novelty sporting accessory provides a three-dimensional polite, clever, and amusing representation of one's sporting enthusiasm for others to behold.

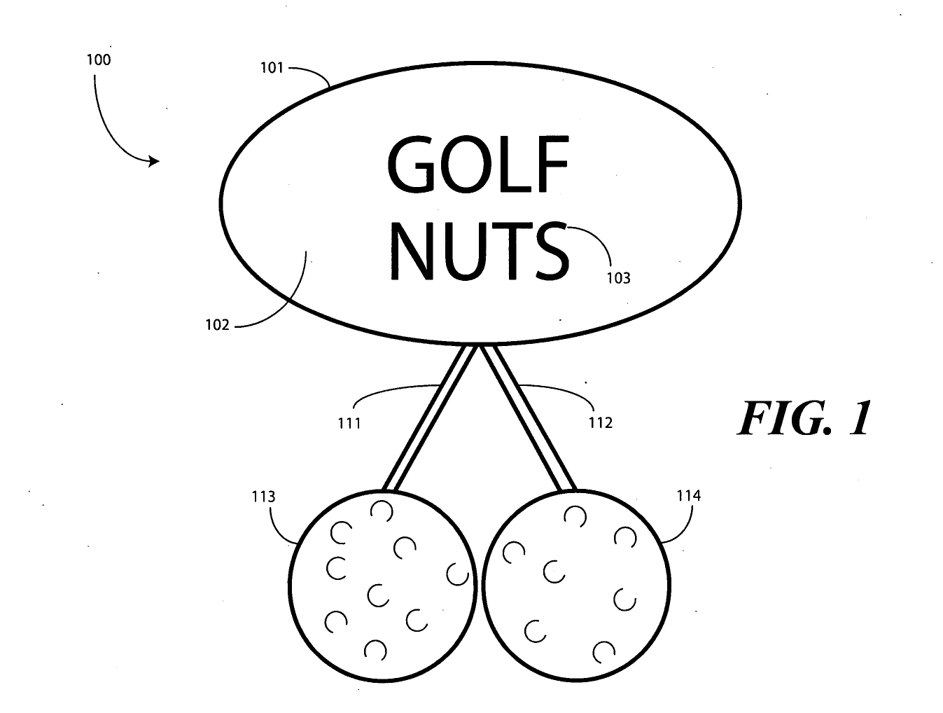

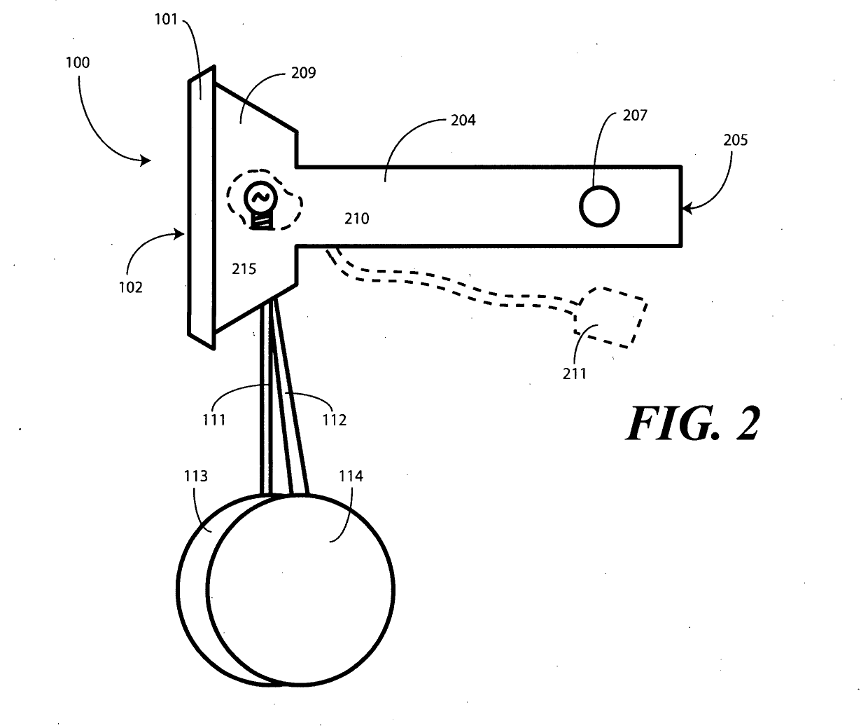

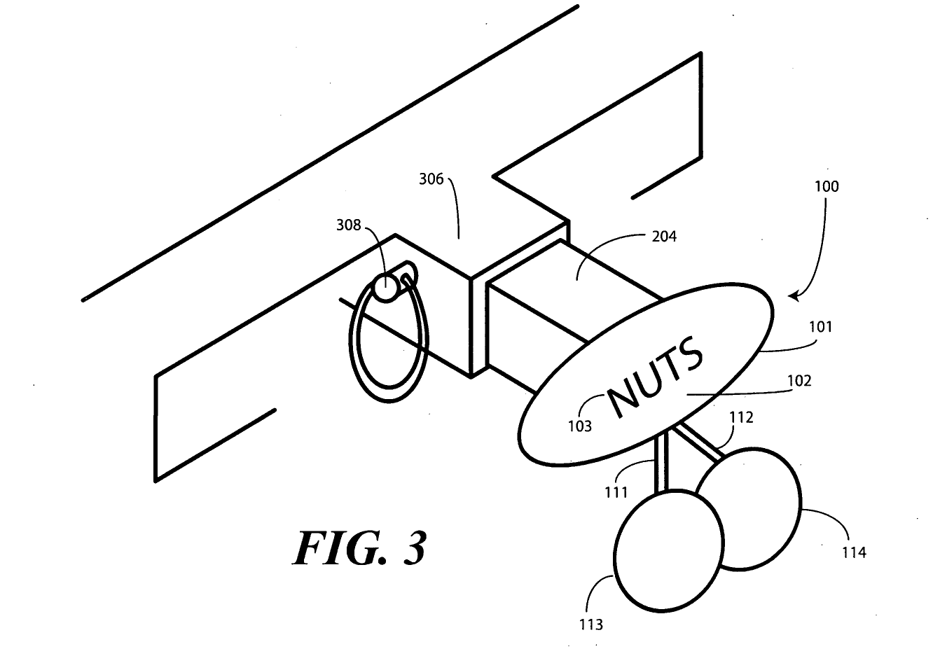

Turning now to FIGS. 1-3, illustrated therein is one embodiment of a novelty sporting accessory 100 in accordance with the invention. The novelty sporting accessory 100 includes a placard 101 having at least one major face 102. The placard 101 can be oval, rectangular, triangular, or other shapes. Further, the placard 101 can be configured to appear as a silhouetted mascot or other emblem relating to a sporting organization or team. The placard 101 can range from two to twenty-four or more inches square.

The major face 102, in one embodiment, is a substantially planar surface made from a rigid material such as metal or plastic and has text 103 or other graphical indicia disposed thereon. The text 103 or graphical indicia can be applied to the major face 102 in a variety of ways, including by adhesive, by direct application such as paint or vapor deposition, by etching, or by other suitable means.

A coupling device 204 is attached to the placard 101 and is configured to detachably couple the novelty sporting accessory 100 to another object. Other objects can include vehicular components, such as a trailer hitch ball or receiver, an antenna, a window, or a rear-view mirror. Alternatively, the other objects can include keys, walls, overhead fan or light pull-chains, and so forth.

In the illustrative embodiment of FIGS. 1-3, the coupling device 204 includes sidewalls and is configured as a hitch insert with one end 205 adapted to secure within a trailer hitch receiver 306. In one embodiment, this end 205 has a locking hole 207 to secure the coupling device 204 within the receiver 306 by way of a ⅝ ths inch or ½ inch locking pin 308. (Note also that the end 205 could be configured with one or more locking tabs that couple in a spring-form fashion to a locking pin hole disposed in a trailer hitch receiver.) For example, the coupling device 204 can be inserted into the receiver 306, and the locking pin 308 can then be placed through the locking hole 207 to secure the coupling device 204 to the hitch receiver 306.

Both the placard 101 and the coupling device 204 can be made from a variety of materials. They can be made of the same material, or from different materials. As mentioned above, the placard 101 can be manufactured from plastic or metal. Additionally, it can be manufactured from wood, resins, composite materials, or other suitable materials. Similarly, the coupling device 204 can be made from a variety of materials including plastic or metal. In one exemplary embodiment suitable for use with the receiver 306, the coupling device 204 is manufactured from 1¼ ths inch or 2 inch square metal tubing to slide within either a standard 1¼ or 2 inch trailer hitch receiver.

While the placard 101 and coupling device 204 can be directly connected, in one embodiment an optional connecting device 209 can be used to couple these two components together. The optional connecting device 209 can be useful, for example, where the placard 101 is interchangeable—such as where a user may want to switch from “Baseball Nuts” to “Football Nuts” depending upon the season. Where this is the case, the optional connecting device 209 can include coupling devices, such as screw bosses, snaps, clasps, or half of a hook and loop assembly. The placard 101 would then include complimentary coupling means.

The optional connecting device 209 can also be used to house electronic components. For instance, in one embodiment the placard 101 is transparent or semi-transparent. In this embodiment the optional connecting device 209 can be equipped with an illumination source 210 such as a light bulb, light emitting diode, fluorescent tube, or other lighting device. This illumination source 210 can then be coupled to the vehicular electrical system by way of an optional electrical coupling 211. As such, the placard can be 101 can be illuminated in low-light situations.

The novelty sporting accessory 100 includes at least a first thin length 111 and a second thin length 112 of flexible material coupled proximately with the placard 101. The thin, flexible material can be rope, string, bungee cord, stretchable or non-stretchable nylon or other synthetic material, or other suitable materials. The first thin length 111 and second thin length 112 of flexible material may be of a particular color. For instance, in one embodiment the first thin length 111 and second thin length 112 of flexible material each comprise black rope.

The first thin length 111 and second thin length 112 of flexible material can be coupled to any of the placard 101, the coupling device 204, or where used, the optional connecting device 209. Where coupled to the placard 101, the first thin length 111 and second thin length 112 of flexible material will generally be coupled to the placard 101 opposite the major face 102. In one embodiment, the first thin length 111 and second thin length 112 of flexible material have lengths of between one and twelve inches.

The first thin length 111 and second thin length 112 of flexible material can be coupled to the novelty sporting accessory 100 in a variety of ways. Suitable coupling systems include knots, hooks, snaps, latches, adhesives, screws, snaps, or other fastening means. Alternatively, the first thin length 111 and second thin length 112 of flexible material can be permanently coupled to the novelty sporting accessory 100 as well.

In one embodiment, the first thin length 111 and second thin length 112 of flexible material are coupled to a common connection point 215 on the novelty sporting accessory 100. Further, in one embodiment the first thin length 111 and second thin length 112 of flexible material are the same, or substantially similar, lengths.

Coupled to the first thin length 111 and second thin length 112 of flexible material are sporting appurtenances 113,114. At least one sporting appurtenance is coupled to each length of material, although multiple sporting appurtenances may be coupled to each length as well. The sporting appurtenances are coupled to the thin lengths of flexible material, in one embodiment, distally from the placard 101 so as to dangle from the placard 101 when the placard 101 or major face 102 is oriented in a vertical position.

The sporting appurtenances 113,114 can be either replica sporting appurtenances or genuine sporting appurtenances. For instance, where the sporting appurtenances are tennis balls, these appurtenances are soft, light, and relatively small. Consequently, others may easily view such appertuances when coupled to a trailer hitch assembly. Additionally, they are not likely to cause any damage to the rear of a vehicle during sudden stops. Where the sporting appurtenances are footballs however, it may be more desirable to use replica footballs for vehicular applications that are both smaller in size and that are made from a softer material than are genuine footballs. As with the optional connecting device, the sporting appurtenances 113,114 can be equipped with lighting devices so as to be illuminated in low-light conditions.

As sporting fans can be interested in a variety of sports, the sporting appurtenances 113,114 can take many forms. By way of example, suitable sports for embodiments of the invention include baseball, basketball, hockey, soccer, football, golf, softball, tennis, racquetball, racket ball, billiards, pool, ping-pong, bowling, and cheerleading. Further, motor sports such as NASCAR®, Indy car, and formula one racing are suitable as well. As such, one of the words in the text 103 may be one of these sports monikers. It will be clear to those of ordinary skill in the art having the benefit of this disclosure that this list is not all-inclusive. There are any number of other sports—including rugby, cricket, croquet and so forth—that are suitable for embodiments of the invention as well.

While the sporting appurtenances 113,114 can be the same, such as the two balls shown in FIGS. 1-3, they need not necessarily be as such. For instance, where the text 103 reads “tennis nuts”, one sporting appurtenance may be a replica tennis ball while the other is a replica tennis racquet, and so forth.

The sporting appurtenances 113,114 will generally change with the sport. For example, where the text 103 reads “football nuts”, the sporting appurtenances 113,114 can be footballs, replica footballs, helmets, or replica helmets. Where the text 103 reads “hockey nuts”, the sporting appurtenances 113,114 may be hockey pucks, replica hockey pucks, or replica hockey sticks, and so forth. Just as the placard 101 can be configured to be interchangeable, so too can the thin flexible material and sporting appurtenances.

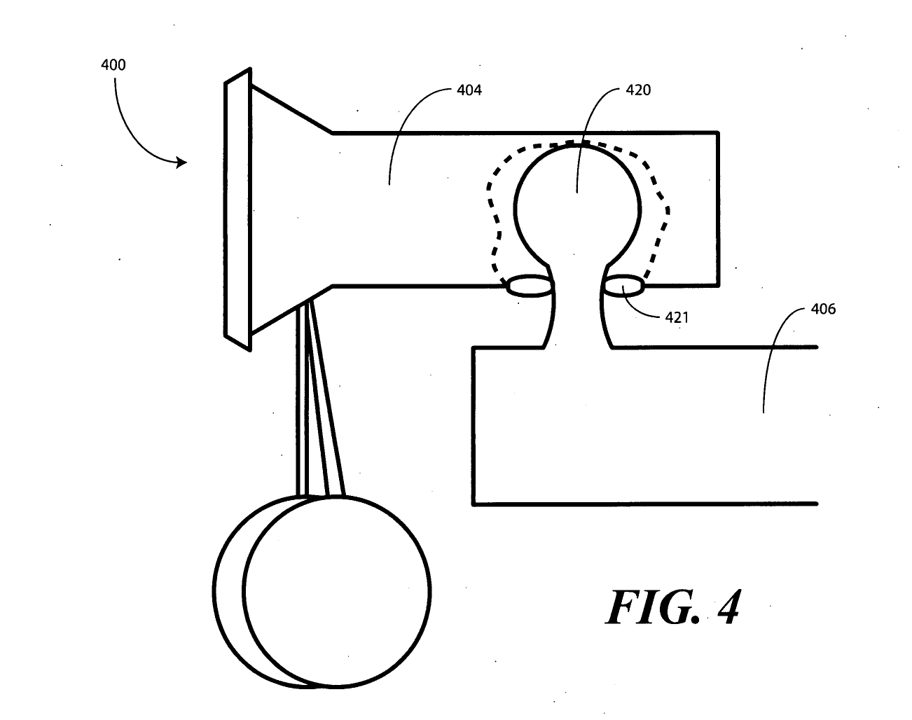

Turning now to FIG. 4, illustrated therein is an alternate embodiment of a novelty sporting accessory 400 in accordance with the invention. In the embodiment of FIG. 4, the coupling device 404 comprises a receiver configured for detachably coupling to a ball 420 of a trailer hitch 406. Such a configuration can be achieved by adding an aperture to one of the sidewalls of the coupling device 404. A gasket 421 may be used to provide friction so as to keep the novelty sporting accessory 400 securely fastened to the ball 421. Alternatively, other connecting means can be used to fasten the novelty sporting accessory 400 to the ball 421, such as a conventional trailer ball clasp or a receptacle which seats on the ball 421 of the trailer hitch 406. The receptacle can be configured as a receiver with a plurality of spring-form fingers that allow the sides of the receptacle to expand and contract so that the ball 421 can be inserted and maintained in frictional engagement with the coupling device 404. The receptacle can be formed from springy metal or plastic, and may be assisted by use of a metal band encircling the receptacle.

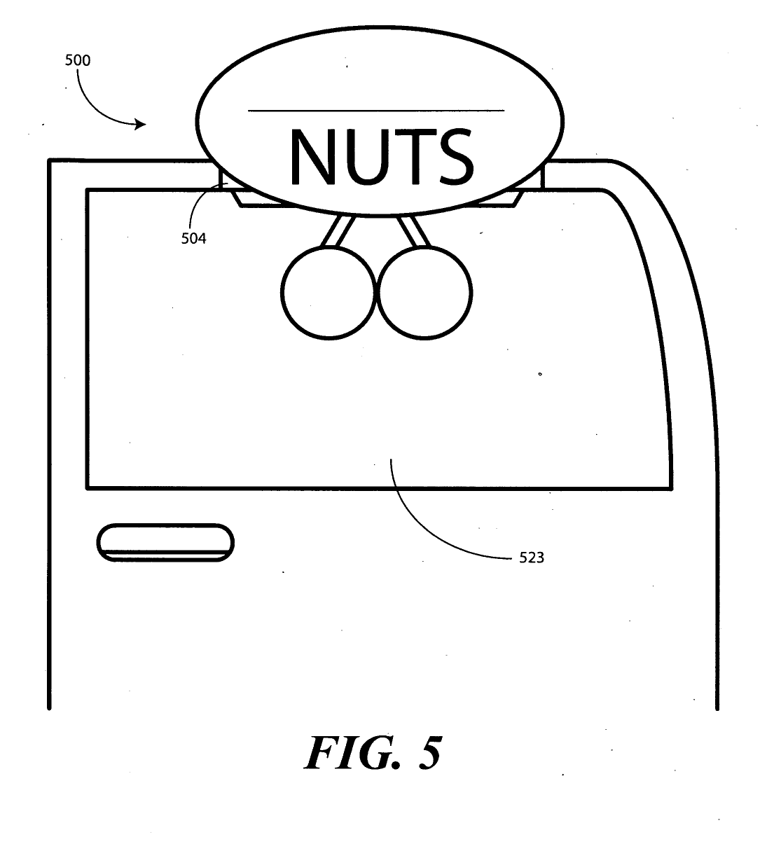

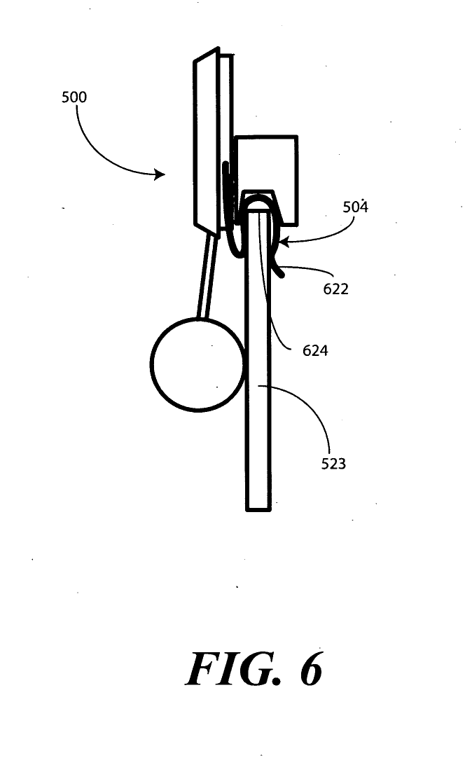

Turning now to FIGS. 5 and 6, illustrated therein are a front, elevation view and side, elevation view, respectively, of an alternative novelty sporting accessory 500 in accordance with the invention. In FIGS. 5 and 6, the coupling device 504 is configured as a spring clasp 622 that is configured to detachably or removably slip over an edge 624 of a window 523. The spring clasp 622 is further configured to mechanically retain the window 523 therein. The spring clasp 622 may be formed from thin, springy metal material, plastic, or another suitable material. Frictional materials may be added to the spring clasp 622 to assist with retention of the pane of automotive window glass within the spring clasp 622. In one embodiment, the spring clasp 622 is configured in an accordion folded configuration.

Turning now to FIG. 7, illustrated therein is another novelty sporting accessory 700 in accordance with the invention. In FIG. 7, the novelty sporting accessory 700 is configured as a keychain. The coupling device 704 includes a linkage 731 and a key ring 730. Note that in the embodiment of FIG. 7, the first thin length 711 and second thin length 712 of thin, flexible material are coupled to the end of the placard 701 by a second linkage 732. As such, the sporting appurtenances 713,714 are configured to dangle when the placard 701 is oriented in the vertical position. The placard 701 of FIG. 7 can be made from a variety of materials, including plastics and flexible rubber materials.

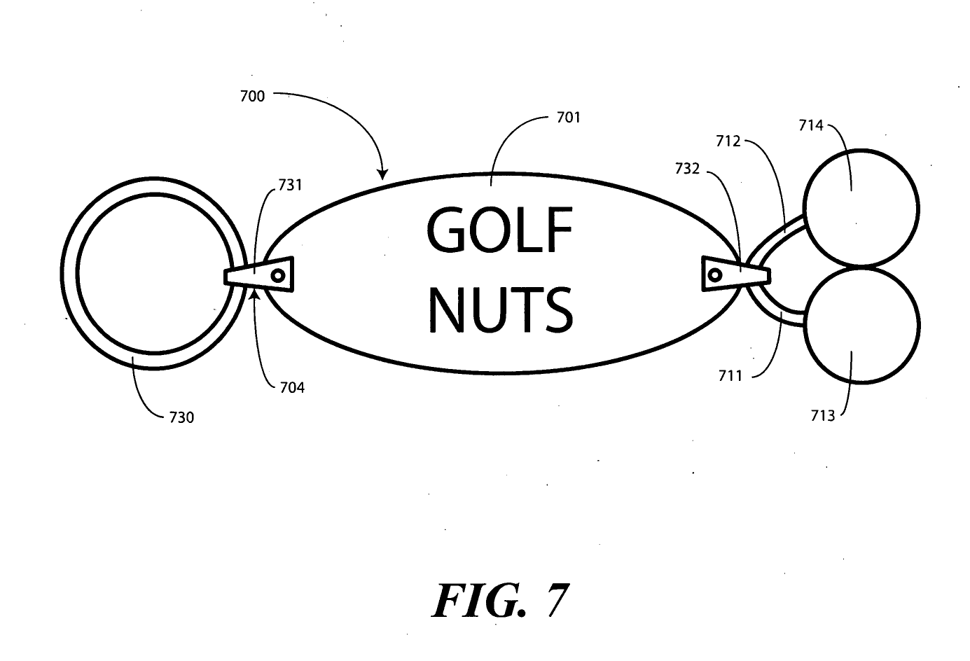

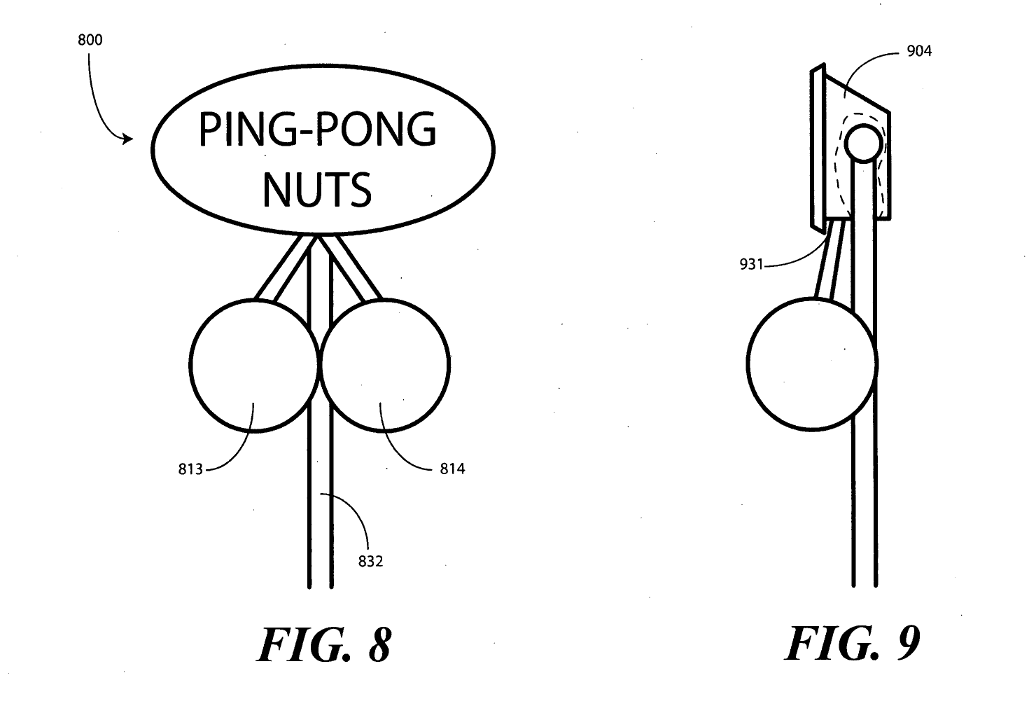

Turning now to FIGS. 8 and 9, illustrated therein is a front, elevation view and a side, elevation view, respectively, of another embodiment of a novelty sporting accessory 800 in accordance with the invention. In FIGS. 8 and 9, the novelty sporting accessory is configured as an “antenna topper” with the connecting device 904 comprising a receiver 931 configured for detachably coupling to a vehicular antenna 832. In such a configuration, the sporting appurtenances 812,814 will generally be replica sporting appurtenances so as to minimize weight, thereby adding to the retention capabilities of the receiver 931. The connecting device 904 in this configuration may be manufactured from Styrofoam, styrene, or other lightweight materials.

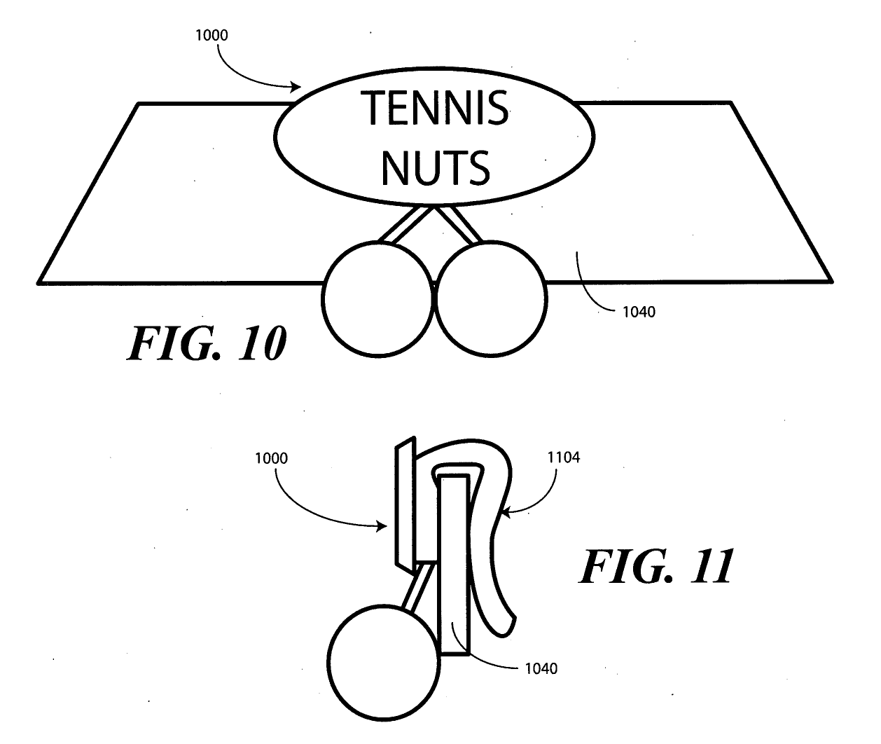

Turning to FIGS. 10 and 11, illustrated therein is another embodiment of a novelty sporting accessory 1000 in accordance with the invention. In these figures, the novelty sporting accessory 1000 is configured so as to couple to a vehicular rear-view mirror 1040. In particular, the coupling device 1104 is configured as a spring clasp configured to detachably coupled to the automotive rear-view mirror 1040. The spring clasp can be manufactured from plastic, metal, or other suitable materials.

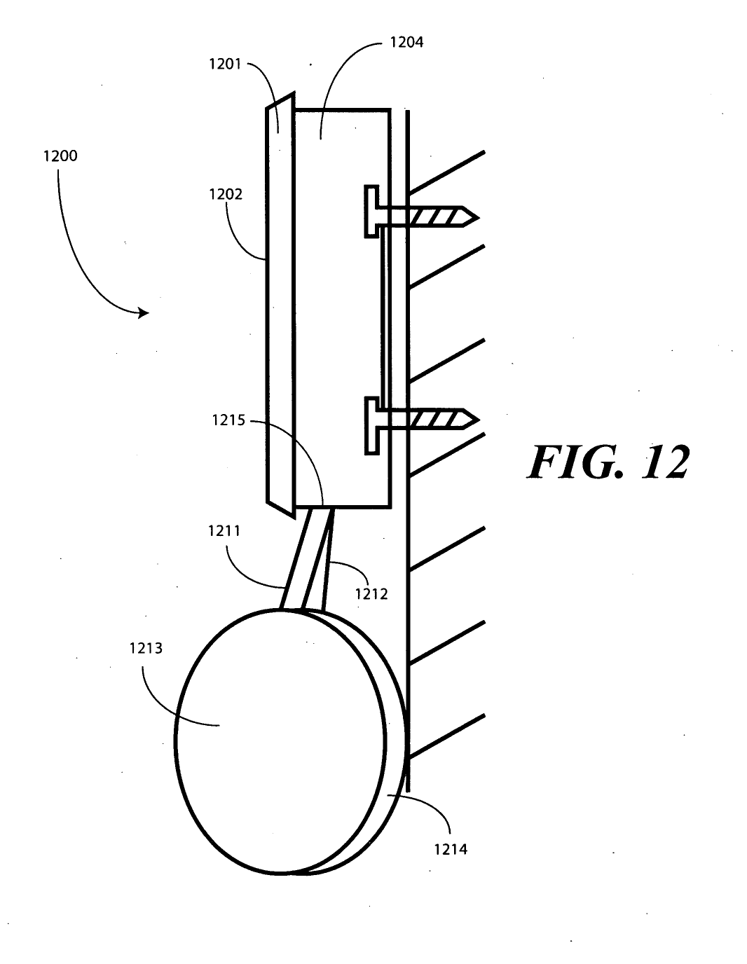

Turning now to FIG. 12, illustrated therein is an alternate embodiment of a novelty sporting accessory 1200 in accordance with the invention. The novelty sporting accessory 1200 of FIG. 12 is configured to be a decorative sporting accessory suitable for hanging on the wall of a home or office. As a wall can hold more weight and is generally bigger than any of the vehicular embodiments, the novelty sporting accessory 1200 can be of much larger size. For example, the placard 1201 can be greater thirty, forty, or more square inches. Further, a wide variety of materials can be used to manufacture the placard 1201, including wood, rare woods, precious metals, and so forth.

Another feature of the novelty sporting accessory 1200 of FIG. 12 is that rather than using replica sporting appurtenances, actual sporting appurtenances can be used. Since a wall can be configured to support a great deal of weight, the sporting appurtenances may comprise actual helmets, bats, clubs, rackets, or balls. Of course, replica sporting appurtenances can also be used with this particular embodiment.

As with the automotive embodiments, the novelty sporting accessory 1200 of FIG. 12 includes a placard 1201 having a major face 1202 with text disposed thereon. The coupling device 1204 is configured as a mounting bracket, suitable for mounting to a wall, that is coupled to the placard 1201. At least two thin, flexible lengths of material 1211,1212 are coupled to either the placard 1201 or the mounting device. In one embodiment, the two thin, flexible lengths of material 1211,1212 are coupled at a single coupling point 1215. Two sporting appurtenances 1213,1214 are coupled to the two thin, flexible lengths of material 1211,1212 so as to dangle from the placard 1201 when the placard is mounted on a wall and arranged in a vertical orientation.

As noted above, these sporting appurtenances 1213,1214 can be actual balls or other objects since the embodiment of FIG. 12 can be large in size. In one embodiment, the sporting appurtenances 1213,1214 comprise at least two sports balls, with at least one of the sports balls coupled to each of the two thin, flexible lengths of material opposite the coupling point 1215. Exemplary balls include golf balls, tennis balls, basketballs, softballs, or racquet balls.

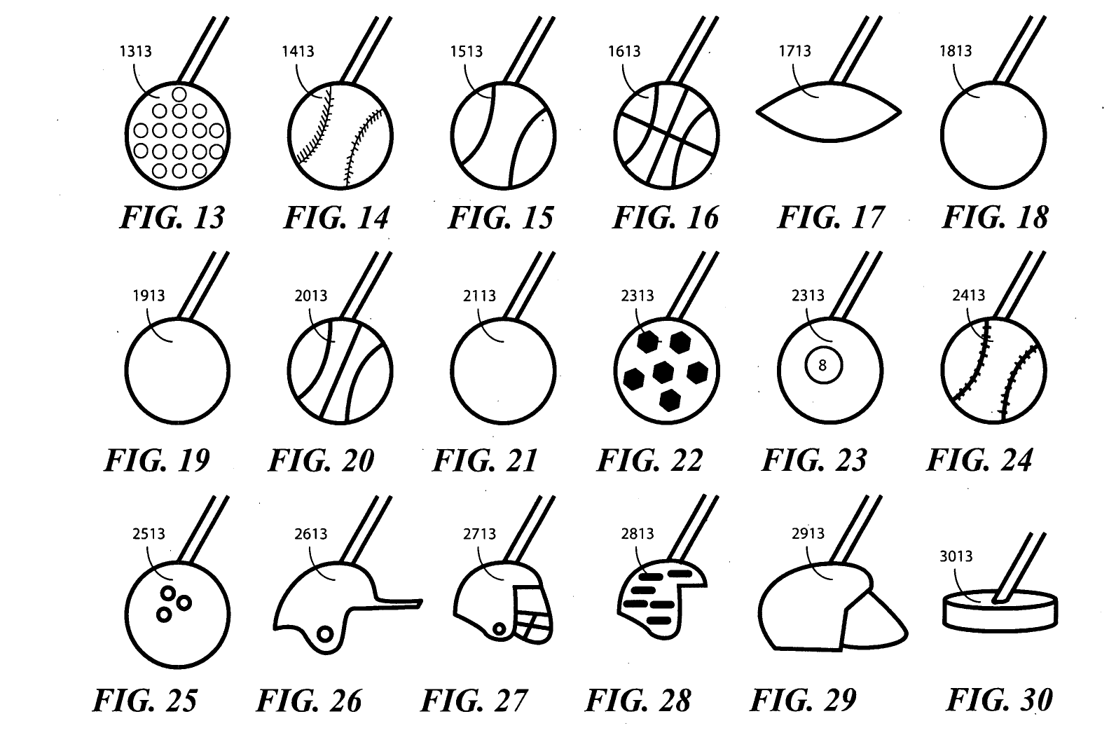

Turning now to FIGS. 13-40, illustrated therein are various sporting appurtenances that may be employed with embodiments of the invention. The appurtenances of FIGS. 13-45 are illustrative only, and are not intended to be all-inclusive. It will be clear to those of ordinary skill in the art having the benefit of this disclosure that a variety of sporting appurtenances not shown will also be more than suitable with embodiments of the invention.

Turning now to FIG. 13, illustrated therein is one exemplary sporting appurtenance 1313. The sporting appurtenance 1313 shown is that of a golf ball. Such an appurtenance can be used, for example, where the text (103) on the placard (101) reads “Golf Nuts.”

Turning now to FIG. 14, illustrated therein is one exemplary sporting appurtenance 1413. The sporting appurtenance 1413 shown is that of a baseball. Such an appurtenance can be used, for example, where the text (103) on the placard (101) reads “Baseball Nuts.”

Turning now to FIG. 15, illustrated therein is one exemplary sporting appurtenance 1513. The sporting appurtenance 1513 shown is that of a tennis ball. Such an appurtenance can be used, for example, where the text (103) on the placard (101) reads “Tennis Nuts.”

Turning now to FIG. 16, illustrated therein is one exemplary sporting appurtenance 1613. The sporting appurtenance 1613 shown is that of a basketball. Such an appurtenance can be used, for example, where the text (103) on the placard (101) reads “Basketball Nuts.”

Turning now to FIG. 17, illustrated therein is one exemplary sporting appurtenance 1713. The sporting appurtenance 1713 shown is that of a football. Such an appurtenance can be used, for example, where the text (103) on the placard (101) reads “Football Nuts.”

Turning now to FIG. 18, illustrated therein is one exemplary sporting appurtenance 1813. The sporting appurtenance 1813 shown is that of a racquetball. Such an appurtenance can be used, for example, where the text (103) on the placard (101) reads “Racquetball Nuts.”

Turning now to FIG. 19, illustrated therein is one exemplary sporting appurtenance 1913. The sporting appurtenance 1913 shown is that of a squash ball. Such an appurtenance can be used, for example, where the text (103) on the placard (101) reads “Squash Nuts.”

Turning now to FIG. 20, illustrated therein is one exemplary sporting appurtenance 2013. The sporting appurtenance 2013 shown is that of a volleyball. Such an appurtenance can be used, for example, where the text (103) on the placard (101) reads “Volleyball Nuts.”

Turning now to FIG. 21, illustrated therein is one exemplary sporting appurtenance 2113. The sporting appurtenance 2113 shown is that of a ping-pong ball. Such an appurtenance can be used, for example, where the text (103) on the placard (101) reads “Ping-Pong Nuts.”

Turning now to FIG. 22, illustrated therein is one exemplary sporting appurtenance 2213. The sporting appurtenance 2213 shown is that of a soccer ball. Such an appurtenance can be used, for example, where the text (103) on the placard (101) reads “Soccer Nuts.”

Turning now to FIG. 23, illustrated therein is one exemplary sporting appurtenance 2313. The sporting appurtenance 2313 shown is that of a ball. Such an appurtenance can be used, for example, where the text (103) on the placard (101) reads “Pool Nuts” or perhaps “Billiard Nuts.”

Turning now to FIG. 24, illustrated therein is one exemplary sporting appurtenance 2413. The sporting appurtenance 2413 shown is that of a softball. Such an appurtenance can be used, for example, where the text (103) on the placard (101) reads “Softball Nuts.”

Turning now to FIG. 25, illustrated therein is one exemplary sporting appurtenance 2513. The sporting appurtenance 2513 shown is that of a bowling ball. Such an appurtenance can be used, for example, where the text (103) on the placard (101) reads “Bowling Nuts.”

Turning now to FIG. 26, illustrated therein is one exemplary sporting appurtenance 2613. The sporting appurtenance 2613 shown is that of a helmet. The helmet can be associated with any of a variety of sports. In FIG. 26, the helmet is a baseball helmet. Such an appurtenance can be used, for example, where the text (103) on the placard (101) reads “Baseball Nuts.”

Turning now to FIG. 27, illustrated therein is one exemplary sporting appurtenance 2713. The sporting appurtenance 2713 shown is that of a football helmet. Such an appurtenance can be used, for example, where the text (103) on the placard (101) reads “Football Nuts.”

Turning now to FIG. 28, illustrated therein is one exemplary sporting appurtenance 2813. The sporting appurtenance 2813 shown is that of a hockey helmet. Such an appurtenance can be used, for example, where the text (103) on the placard (101) reads “Hockey Nuts.”

Turning now to FIG. 29, illustrated therein is one exemplary sporting appurtenance 2913. The sporting appurtenance 2913 shown is that of a racing helmet. Such an appurtenance can be used, for example, where the text (103) on the placard (101) reads “Racing Nuts.”

Turning now to FIG. 30, illustrated therein is one exemplary sporting appurtenance 3013. The sporting appurtenance 3013 shown is that of a hockey puck. Such an appurtenance can be used, for example, where the text (103) on the placard (101) reads “Hockey Nuts.”

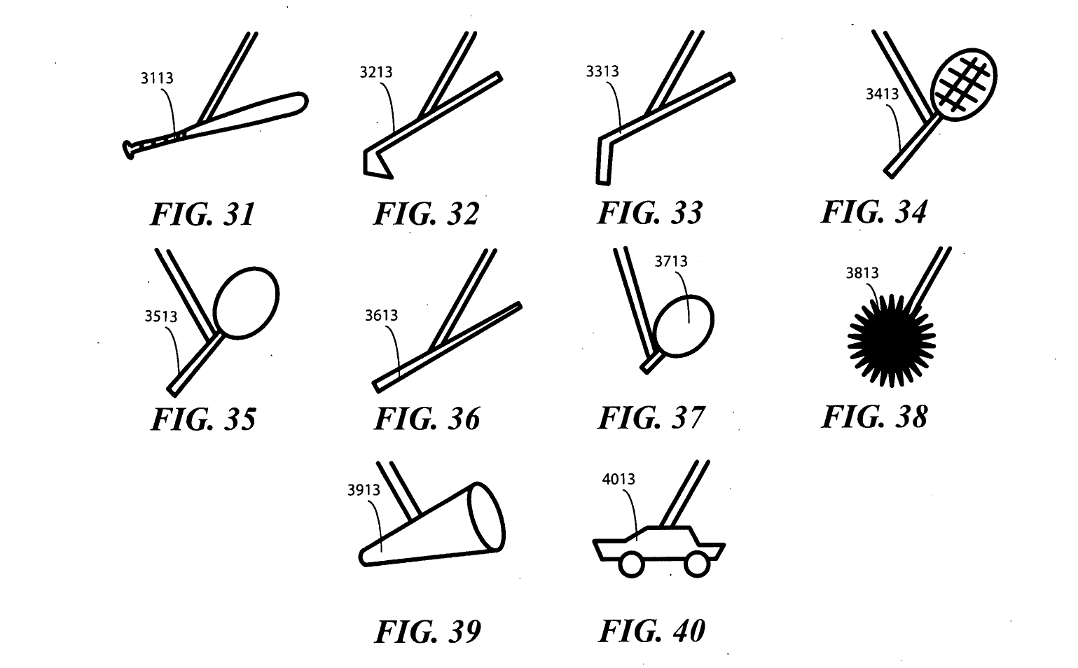

Turning now to FIG. 31, illustrated therein is one exemplary sporting appurtenance 3113. The sporting appurtenance 3113 shown is that of a baseball bat. Such an appurtenance can be used, for example, where the text (103) on the placard (101) reads “Baseball Nuts.”

Turning now to FIG. 32, illustrated therein is one exemplary sporting appurtenance 3213. The sporting appurtenance 3213 shown is that of a golf club. Such an appurtenance can be used, for example, where the text (103) on the placard (101) reads “Golf Nuts.”

Turning now to FIG. 33, illustrated therein is one exemplary sporting appurtenance 3313. The sporting appurtenance 3313 shown is that of a hockey stick. Such an appurtenance can be used, for example, where the text (103) on the placard (101) reads “Hockey Nuts.”

Turning now to FIG. 34, illustrated therein is one exemplary sporting appurtenance 3413. The sporting appurtenance 3413 shown is that of a tennis racquet. Such an appurtenance can be used, for example, where the text (103) on the placard (101) reads “Tennis Nuts.”

Turning now to FIG. 35, illustrated therein is one exemplary sporting appurtenance 3513. The sporting appurtenance 3513 shown is that of a racquetball racquet. Such an appurtenance can be used, for example, where the text (103) on the placard (101) reads “Racquetball Nuts.”

Turning now to FIG. 36, illustrated therein is one exemplary sporting appurtenance 3613. The sporting appurtenance 3613 shown is that of a pool cue. Such an appurtenance can be used, for example, where the text (103) on the placard (101) reads “Pool Nuts” or perhaps “Billiard Nuts.”

Turning now to FIG. 37, illustrated therein is one exemplary sporting appurtenance 3713. The sporting appurtenance 3713 shown is that of a ping-pong paddle. Such an appurtenance can be used, for example, where the text (103) on the placard (101) reads “Ping-pong Nuts.”

Turning now to FIG. 38, illustrated therein is one exemplary sporting appurtenance 3813. The sporting appurtenance 3813 shown is that of a cheerleading pom-pom. Such an appurtenance can be used, for example, where the text (103) on the placard (101) reads “Cheerleading Nuts.”

Turning now to FIG. 39, illustrated therein is one exemplary sporting appurtenance 3913. The sporting appurtenance 3913 shown is that of a megaphone. Such an appurtenance can be used, for example, where the text (103) on the placard (101) reads “Cheerleading Nuts” or perhaps “Singing Nuts.”

Turning now to FIG. 40, illustrated therein is one exemplary sporting appurtenance 4013. The sporting appurtenance 4013 shown is that of a replica car. Such an appurtenance can be used, for example, where the text (103) on the placard (101) reads “Racing Nuts.”

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

1. A novelty sports accessory, comprising:
a placard having at least one major face with text disposed thereon;
a coupling device attached to the placard, the coupling device being configured to detachably couple the novelty sports accessory to another object;
at least a first thin length and a second thin length of flexible material coupled proximately with the placard; and
at least a first replica sporting appurtenance coupled to the first thin length of flexible material distally from the placard, and a second replica sporting appurtenance coupled to the second thin length of flexible material distally from the placard.

2. The novelty sports accessory of claim 1, wherein the first replica sporting appurtenance and the second replica sporting appurtenance are configured to dangle from the placard when the placard is oriented such that the at least one major face is substantially vertical.

3. The novelty sports accessory of claim 1, wherein the first thin length and the second thin length of flexible material are coupled to a common connection point on the novelty sports accessory.

4. The novelty sports accessory of claim 3, wherein the first thin length and the second thin length of flexible material have substantially similar lengths.

5. The novelty sports accessory of claim 4, wherein each of the first thin length and the second thin length of flexible material comprise one of rope or string.

6. The novelty sports accessory of claim 1, wherein the text comprises at least one word, wherein the at least one word comprises nuts.

7. The novelty sports accessory of claim 6, wherein the text further comprises a word selected from the group consisting of baseball, hockey, basketball, soccer, football, golf, softball, tennis, racquetball, racketball, NASCAR, billiard, pool, ping pong, bowling, and cheerleading.

8. (canceled)

9. The novelty sports accessory of claim 1, wherein the coupling device comprises a vehicular hitch insert configured for removable insertion into a trailer hitch receiver.

10. The novelty sports accessory of claim 9, wherein the vehicular hitch insert comprises sidewalls and one of a pin receiving hole or a plurality of locking tabs attached to the sidewalls.

11. The novelty sports accessory of claim 10, wherein the vehicular hitch insert is manufactured from one of metal, plastic, or composite material.

12. (canceled)

13. (canceled)

14. (canceled)

15. (canceled)

16. (canceled)

17. (canceled)

18. The novelty sports accessory of claim 1, wherein at least the first replica sporting appurtenance comprises a replica sports ball.

19. The novelty sports accessory of claim 18, wherein the replica sports ball comprises one of a baseball, a football, a basketball, a golf ball, a tennis ball, a racquet ball, a squash ball, a volleyball, a ping pong ball, a soccer ball, a billiard ball, a softball, or a bowling ball.

20. The novelty sports accessory of claim 1, wherein at least the first replica sporting appurtenance comprises a replica helmet.

21. The novelty sports accessory of claim 20, wherein the replica helmet comprises one of a football helmet, a baseball helmet, a hockey helmet, or a racing helmet.

22. The novelty sports accessory of claim 1, wherein at least the first replica sporting appurtenance comprises one of a hockey puck, baseball bat, a golf club, a hockey stick, a tennis racquet, a racquetball racquet, a pool cue, or a ping pong paddle.

23. The novelty sports accessory of claim 1, wherein at least the first replica sporting appurtenance comprises one of a cheerleading megaphone or a pom-pom.

24. (canceled)

25. A decorative sports accessory, comprising;
a placard having a major face with text disposed thereon;
a mounting device coupled to the placard;
at least two thin, flexible lengths of material coupled to one of the placard or the mounting device at a coupling point; and
at least two sports balls, with at least one of the at least two sports balls coupled to each of the at least two thin, flexible lengths of material opposite the coupling point;
wherein the at least two sports balls dangle from the placard when the placard is arranged in a substantially vertical orientation.

26. The decorative sports accessory of claim 25, wherein the at least two sports balls comprise at least one of a golf ball, a tennis ball, a baseball, a softball, or a racquetball.

27. (canceled)

28. The decorative sports accessory of claim 25, wherein the at least to sports balls comprise at least one of a golf ball or a tennis ball, further wherein the mounting device comprises one of a wall mount bracket or a vehicular hitch insert.
